(19) United States
(12) Patent Application Publication
(10) Pub. No.: US 2026/0054340 A1
(43) Pub. Date: Feb. 26, 2026

(54) MACHINE TOOL

(71) Applicant: FANUC CORPORATION, Minamitsuru-gun, Yamanashi (JP)

(72) Inventor: Taisei FUJIMOTO, Minamitsuru-gun, Yamanashi (JP)

(21) Appl. No.: 19/102,536

(22) PCT Filed: Oct. 21, 2022
(86) PCT No.: PCT/JP2022/039387

§ 371 Date: Feb. 10, 2025

(51) Int. Cl. B23Q 5/36; G05B 19/4062

(52) U.S. Cl. CPC B23Q 5/36; G05B 19/4062; G05B 2219/34306

(57) ABSTRACT

A machine tool according to an aspect of the present disclosure comprises: a plurality of servo motors; a plurality of servo amplifiers that drive the servo motors, respectively; and a numerical value control device that inputs a command value to the plurality of servo amplifiers in accordance with a processing program. The numerical value control device has: a motor classification unit that classifies the plurality of servo motors into continuous drive motors which require continuous excitation during execution of the processing program and intermittent drive motors in which excitation can be stopped at least temporarily during the execution of processing program; and a stop control unit that stops the excitation of at least one of the intermittent drive motors during the execution of the processing program.

### TECHNICAL FIELD

The present invention relates to a machine tool.

### BACKGROUND ART

A machine tool machines a workpiece by operating a plurality of servo motors in cooperation with each other. In general, the servo motors correspond to servo amplifiers on a one-to-one basis and are each driven by a current supplied from the corresponding servo amplifier. Each servo motor is excited even when its output shaft is not to be displaced, and the output is adjusted such that a rotational position of the servo motor coincides with a target position on each occasion.

As described above, the servo motors of a machine tool are normally always in a state of excitation and consume electric power. An exception is the occurrence of a power failure or the like. In order to prevent a feed shaft from colliding (interfering with another shaft or the limit of a range of motion) in the case of a power failure or the like, a technique has been proposed in which power supply to a servo motor is interrupted when an abnormality is detected (for example, see Patent Document 1).

### CITATION LIST

### Patent Document

Patent Document 1: Japanese Unexamined Patent Application, Publication No. 2014-96929

### DISCLOSURE OF THE INVENTION

### Problems to be Solved by the Invention

In recent years, there has been an increasing demand for energy conservation, and machine tools are required to be more energy efficient. Therefore, a technique capable of reducing power consumption of a servo motor is desired.

### Means for Solving the Problems

A machine tool according to an aspect of the present disclosure includes: a plurality of servo motors; a plurality of servo amplifiers that drive the plurality of servo motors, respectively; and a numerical controller that inputs command values to the plurality of servo amplifiers in accordance with a machining program. The numerical controller includes a motor classification unit that classifies the plurality of servo motors into one or more continuous drive motors that require continuous excitation while the machining program is being executed and one or more intermittent drive motors excitation of which can be stopped at least temporarily while the machining program is being executed, and a stop control unit that stops excitation of at least one of the one or more intermittent drive motors when the machining program is being executed.

### BRIEF DESCRIPTION OF THE DRAWINGS

FIG. 1 is a schematic diagram illustrating a configuration of a machine tool according to an embodiment of the present disclosure.

### PREFERRED MODE FOR CARRYING OUT THE INVENTION

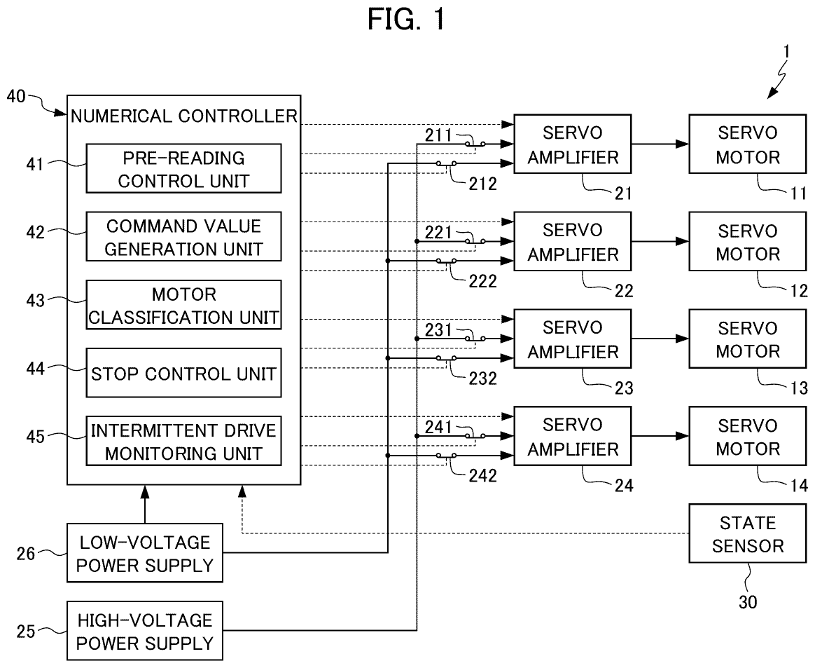

Embodiments of the present disclosure will be described below with reference to the drawings. FIG. 1 is a schematic diagram illustrating a configuration of a machine tool 1 according to an embodiment of the present disclosure.

The machine tool 1 includes: a plurality of servo motors 11, 12, 13, and 14; a plurality of servo amplifiers 21, 22, 23, and 24 that drive the servo motors 11, 12, 13, and 14, respectively; a state sensor 30 that detects an operation state of a member driven by the fourth servo motor 14; and a numerical controller 40 that inputs command values to the plurality of servo amplifiers 21, 22, 23, and 24 in accordance with a machining program.

The servo motors 11, 12, 13, and 14 include a spindle motor 11 that relatively rotates a tool and a workpiece, a plurality of positioning shaft motors 12 and 13 that relatively move a tool and the workpiece, and an auxiliary motor 14 that drives peripheral equipment (e.g., a servo motor that drives a door). Although FIG. 1, which is a schematic diagram, illustrates the four servo motors 11, 12, 13, and 14 and the four servo amplifiers 21, 22, 23, and 24, the number of servo motors and that of servo amplifiers are not limited and are usually greater than four in practice.

As will be described later in detail, in the present embodiment, the spindle motor 11 and the positioning shaft motors 12 and 13 are each handled as a continuous drive motor that requires continuous excitation while a machining program is being executed, and the auxiliary motor 14 is handled as an intermittent drive motor excitation of which can be stopped at least temporarily while the machining program is being executed.

The servo amplifiers 21, 22, 23, and 24 are provided in correspondence with the servo motors 11, 12, 13, and 14 on a one-to-one basis, and each supply an excitation current for exciting a winding of the corresponding one of the servo motors 11, 12, 13, and 14. The servo amplifiers 21, 22, 23, and 24 may be configured to regulate the currents to be inputted to the servo motors 11, 12, 13, and 14 so that the respective speeds of the servo motors 11, 12, 13, and 14 are adjusted to the speeds indicated by the command values inputted from the numerical controller 40.

Each of the servo amplifiers 21, 22, 23, and 24 is supplied with drive power from a high-voltage power supply 25 and control power from a low-voltage power supply 26. The drive power from the high-voltage power supply 25 is supplied to the servo amplifiers 21, 22, 23, and 24 via electric circuits respectively provided with primary breakers 211, 221, 231, and 241 that are operated by the numerical controller 40. The control power from the low-voltage power supply 26 is supplied to the servo amplifiers 21, 22, 23, and 24 via electric circuits respectively provided with relays 212, 222, 232, and 242 that are operated by the numerical controller 40.

The servo amplifiers 21, 22, 23, and 24 are configured to interrupt their outputs to thereby stop the excitation of the servo motors 11, 12, 13, and 14 in response to an input of a stop signal from the numerical controller 40. The mechanism for stopping the excitation may be secondary breakers capable of disconnecting electric circuits via which the main bodies of the servo amplifiers 21, 22, 23, and 24 are connected to the servo motors 11, 12, 13, and 14.

The state sensor 30 may be configured to detect the position of a member, such as a door, that is driven by the auxiliary motor 14. The state sensor 30 may be, for example, a phototube, a limit switch, etc.

The numerical controller 40 includes a pre-reading control unit 41, a command value generation unit 42, a motor classification unit 43, a stop control unit 44, and an intermittent drive monitoring unit 45. The numerical controller 40 can be implemented by one or more computer devices each include, for example, a memory, a processor (CPU), an input/output interface, and the like, and execute an appropriate control program. The foregoing constituent elements of the numerical controller 40 refer to categorized functions of the numerical controller 40, and do not have to be clearly distinguishable from each other in terms of physical configuration and program configuration.

The pre-reading control unit 41 pre-reads a machining program before the servo motors 11, 12, 13, and 14 are actually operated, and corrects motions described in the machining program. More specifically, in consideration of mechanical limitations of the servo motors 11, 12, 13, and 14, such as a maximum speed, a maximum acceleration, a maximum jerk, etc., the pre-reading control unit 41 calculates in advance speeds and the like for each clock time at which instructions are to be given to the servo motors 11, 12, 13, and 14 such that the machining according to the machining program can be performed as accurately as possible, and stores therein information regarding the calculated motions until the servo motors 11, 12, 13, and 14 are actually operated.

The command value generation unit 42 generates command values to be inputted to the servo amplifiers 21, 22, 23, and 24, based on information regarding the motions corrected by the pre-reading control unit 41. The command value generation unit 42 may be configured to correct the command values to be inputted to the servo amplifiers 21, 22, 23, and 24 in consideration of feedback signals indicating actual speeds of the servo motors 11, 12, 13, and 14.

The motor classification unit 43 classifies the plurality of servo motors 11, 12, 13, and 14 into one or more continuous drive motors 11, 12, 13 that require continuous excitation while the machining program is being executed and one or more intermittent drive motors 14 excitation of which can be stopped at least temporarily while the machining program is being executed.

Although the motor classification unit 43 may classify the servo motors into the one or more continuous drive motors and the one or more intermittent drive motors according to setting made at the time of installation of the machine tool 1, it is preferable that the motor classification unit 43 is configured to classify the servo motors into the one or more continuous drive motors and the one or more intermittent drive motors according to an input from an external source. The input according to which the servo motors are classified into the one or more continuous drive motors and the one or more intermittent drive motors may be provided by a user, or may be provided by the numerical controller 40 communicating with an external server or the like.

The motor classification unit 43 may be configured to classify the same servo motor as the continuous drive motor or the intermittent drive motor depending on each machining program. For example, in the case of a machine tool equipped with a tool changer, the servo motor for the tool changer is preferably handled as the continuous drive motor in order to prevent a delay in machining when a machining program according to which tool change is frequently performed is executed, whereas the servo motor for the tool changer is preferably handled as the intermittent drive motor in order to reduce energy consumption when a machining program according to which tool change is not performed is executed. For this reason, the motor classification unit 43 may store information for specifying classification between the continuous drive motor and the intermittent drive motor in association with machining programs.

The motor classification unit 43 may be configured to check information regarding classification between the continuous drive motor and the intermittent drive motor, which is additionally described in a machining program. However, the motor classification unit 43 is preferably configured to analyze the contents of machining described in a machining program to thereby classify the servo motors into the one or more continuous drive motors and the one or more intermittent drive motors because this configuration allows for use of conventional machining programs in which such information regarding the classification is not described. Specifically, the motor classification unit 43 may be configured to classify, as the intermittent drive motor, a servo motor that is determined not to need to be driven for a predetermined stop period or longer in a machining program. The “stop period” may be specified not only in units of time but also in units of the number of blocks in the machining program, for example. Specifically, the stop period can be set to a range of 3 minutes or more and 10 minutes or less, a range of 1000 blocks or more and 5000 blocks or less, or a similar range.

The motor classification unit 43 may be configured to specify the intermittent drive motor by checking the contents of a machining program in advance before the machining program is executed. In order to shorten a waiting time during machining, the motor classification unit 43 may be configured to classify, as the intermittent drive motor, a servo motor that is determined not to need to be driven for the stop period or longer from the current point in time, based on the contents of a machining program pre-read by the pre-reading control unit 41. In this case, the classification between the continuous drive motor and the intermittent drive motor can be dynamically changed while the machining program is being executed.

The stop control unit 44 stops excitation of at least one of the one or more intermittent drive motors while the machining program is being executed. Specifically, the stop control unit 44 causes the servo amplifier 24, which is for driving the intermittent drive motor 14 that is not used in machining, to stop outputting the excitation current. This configuration makes it possible to reduce power consumption, while preventing a delay in machining.

In addition to causing the servo amplifier 24, which is for driving the intermittent drive motor 14, to stop outputting the excitation current, the stop control unit 44 may interrupt the supply of drive power to the servo amplifier 24. That is, the stop control unit 44 may open the primary breaker 241. This configuration makes it possible to further reduce power consumption. The stop control unit 44 may further interrupt the supply of control power to the servo amplifier 24, which is for driving the intermittent drive motor 14. That is, the stop control unit 44 may open the relay 242. This configuration makes it possible to reduce power consumption in the control circuit of the servo amplifier 24 as well. The stop of output of the excitation current, the interruption of the supply of drive power, and the interruption of the supply of control power are preferably performed in this order in order to prevent malfunction. When starting excitation of the intermittent drive motor 14, it is preferable to supply electricity in the reverse order.

In a case where the motor classification unit 43 dynamically classifies a servo motor as the intermittent drive motor based on the contents of a pre-read machining program, it is preferable that, in response to the motor classification unit 43 specifying the servo motor as the intermittent drive motor, the stop control unit 44 immediately stops the excitation of the specified intermittent drive motor to reduce power consumption.

In synchronization with the stop of excitation of the intermittent drive motor 14, the stop control unit 44 may interrupt power supply to other equipment that is associated in advance with the intermittent drive motor 14. For example, in a case where the excitation of an auxiliary motor for driving a door is stopped, the power supply to a switch for opening and closing the door, an illumination device that operates in conjunction with the door, and the like may be interrupted.

The stop control unit 44 is preferably configured to excite the intermittent drive motor 14 when it is determined that the intermittent drive motor 14 needs to be driven within a predetermined actuation period from the current point in time based on the contents of a machining program pre-read by the pre-reading control unit 41. The “actuation period” is set to a time sufficient for actuating the intermittent drive motor 14, the number of blocks with which such a time can be ensured, or the like. This configuration makes it possible to avoid a delay that can be caused when the intermittent drive motor 14 is actuated after a motion of the intermittent drive motor 14 becomes necessary in practical machining.

The intermittent drive monitoring unit 45 checks whether the intermittent drive motor 14 performs an unintended motion while the excitation of the intermittent drive motor (auxiliary motor) 14 is stopped by the stop control unit. The intermittent drive monitoring unit 45 may be configured to monitor a value detected by the state sensor 30 or may be configured to monitor feedback from an encoder provided in the intermittent drive motor 14 when the encoder is enabled while the intermittent drive motor 14 is stopped from being excited. Due to this configuration, the machine tool 1 can ensure safety of the operation related to the intermittent drive motor 14 even while the control of the intermittent drive motor 14 is stopped.

As described above, the machine tool 1, which includes the motor classification unit 43 that classifies the plurality of servo motors 11, 12, 13, and 14 into the one or more continuous drive motors 11, 12, and 13 and the one or more intermittent drive motors 14, and the stop control unit 44 that stops excitation of the intermittent drive motor 14 while a machining program is being executed, is capable of reducing power consumption caused by the excitation of the intermittent drive motor 14.

The following additional remarks are further disclosed in relation to the above-described embodiments and modifications.

### (Additional Remark 1)

A machine tool (1) includes: a plurality of servo motors (11, 12, 13, 14); a plurality of servo amplifiers (21, 22, 23, 24) that drive the plurality of servo motors (11, 12, 13, 14), respectively; and a numerical controller (40) that inputs command values to the plurality of servo amplifiers (21, 22, 23, 24) in accordance with a machining program. The numerical controller (40) includes: a motor classification unit (43) that classifies the plurality of servo motors (11, 12, 13, 14) into one or more continuous drive motors (11, 12, 13) that require continuous excitation while the machining program is being executed and one or more intermittent drive motors (14) excitation of which can be stopped at least temporarily while the machining program is being executed; and a stop control unit (44) that stops excitation of at least one of the one or more intermittent drive motors (14) when the machining program is being executed.

### (Additional Remark 2)

In the machine tool (1) according to Additional Remark 1, the stop control unit (44) may interrupt supply of drive power to the servo amplifier (24) that drives the at least one of the one or more intermittent drive motors (14).

### (Additional Remark 3)

In the machine tool (1) according to Additional Remark 2, the stop control unit (44) may further interrupt supply of control power to the servo amplifier (24) that drives the at least one of the one or more intermittent drive motors (14).

### (Additional Remark 4)

The machine tool (1) according to Additional Remarks 1 to 3 may further include a state sensor (30) that detects an operation state of one or more members driven by the one or more intermittent drive motors (14).

### (Additional Remark 5)

In the machine tool (1) according to Additional Remarks 1 to 4, the motor classification unit (43) may classify one or more of the servo motors as the one or more intermittent drive motors (14) in accordance with an input from an external source.

### (Additional Remark 6)

In the machine tool (1) according to Additional Remarks 1 to 5, the motor classification unit (43) may classify one or more of the: servo motors (11, 12, 13, 14) that are determined not to need to be driven for a predetermined stop period or longer in the machining program as the one or more intermittent drive motors (14).

### (Additional Remark 7)

In the machine tool (1) according to Additional Remark 6, the numerical controller (40) further includes a pre-reading control unit (41) that pre-reads the machining program and corrects a motion described in the machining program, the motor classification unit (43) classifies one or more of the servo motors (11, 12, 13, 14) that are determined not to need to be driven for the stop period or longer from the current point in time as the one or more intermittent drive motors (14), based on a content of the machining program pre-read by the pre-reading control unit (41), and the stop control unit (44) may immediately stop the excitation of the one or more intermittent drive motors (14) in response to the motor classification unit (43) specifying the one or more intermittent drive motors (14).

### (Additional Remark 8)

In the machine tool (1) according to Additional Remark 7, the stop control unit (44) may excite the one or more intermittent drive motors (14) in a case where the one or more intermittent drive motors (14) are determined to need to be driven within a predetermined actuation period from the current point in time, based on a content of the machining program pre-read by the pre-reading control unit (41).

### (Additional Remark 9)

In the machine tool (1) according to Additional Remarks 1 to 8, the stop control unit (44) may interrupt power supply to other equipment in synchronization with the stop of the excitation of the one or more intermittent drive motors (14).

In the foregoing, the present disclosure has been described in detail. It should be noted that the present disclosure is not limited to the individual embodiments described above. Various additions, substitutions, modifications, partial deletions, and the like can be made to the above embodiments without departing from the spirit of the present disclosure or the spirit of the present disclosure derived from the matters described in the claims and the equivalents thereof.

For example, the machine tool according to the present disclosure may include another component for achieving energy conservation, such as a component for activating a screen saver and a component for turning off a pump, independently of the stop control unit.

### EXPLANATION OF REFERENCE NUMERALS

1: Machine tool
11, 12, 13, 14: Servo motor
21, 22, 23, 24: Servo amplifier
211, 221, 231, 241: Primary breaker
212, 222, 232, 242: Relay
25: High-voltage power supply
26: Low-voltage power supply
30: State sensor
40: Numerical controller
41: Pre-reading control unit
42: Command value generation unit
43: Motor classification unit
44: Stop control unit
45: Intermittent drive monitoring unit

1. A machine tool comprising:
a plurality of servo motors;
a plurality of servo amplifiers that drive the plurality of servo motors, respectively; and
a numerical controller that inputs command values to the plurality of servo amplifiers in accordance with a machining program,
the numerical controller comprising
a motor classification unit that classifies the plurality of servo motors into one or more continuous drive motors that require continuous excitation while the machining program is being executed and one or more intermittent drive motors excitation of which can be stopped at least temporarily while the machining program is being executed, and
a stop control unit that stops excitation of at least one of the one or more intermittent drive motors when the machining program is being executed.

2. The machine tool according to claim 1, wherein
the stop control unit interrupts supply of drive power to one or more of the servo amplifiers that drive the at least one of the one or more intermittent drive motors.

3. The machine tool according to claim 2, wherein
the stop control unit further interrupts supply of control power to the servo amplifier that drives the at least one of the one or more intermittent drive motors.

4. The machine tool according to claim 1, further comprising:
a state sensor that detects an operation state of one or more members driven by the one or more intermittent drive motors.

5. The machine tool according to claim 1, wherein
the motor classification unit classifies one or more of the servo motors as the one or more intermittent drive motors in accordance with an input from an external source.

6. The machine tool according to claim 1, wherein
the motor classification unit classifies one or more of the servo motors that are determined not to need to be driven for a predetermined stop period or longer in the machining program as the one or more intermittent drive motors.

7. The machine tool according to claim 6, wherein
the numerical controller further comprises a pre-reading control unit that pre-reads the machining program and corrects a motion described in the machining program,
the motor classification unit classifies one or more of the servo motors that are determined not to need to be driven for the stop period or longer from a current point in time as the one or more intermittent drive motors, based on a content of the machining program pre-read by the pre-reading control unit, and
the stop control unit immediately stops excitation of the one or more intermittent drive motors in response to the motor classification unit specifying the one or more intermittent drive motors.

8. The machine tool according to claim 7, wherein
the stop control unit excites the one or more intermittent drive motors in a case where the one or more intermittent drive motors are determined to need to be driven within a predetermined actuation period from the current point in time, based on a content of the machining program pre-read by the pre-reading control unit.

9. The machine tool according to claim 1, wherein
the stop control unit interrupts power supply to other equipment in synchronization with stop of the excitation of the one or more intermittent drive motors.
